(19) United States
(12) Patent Application Publication
(10) Pub. No.: US 2006/0294128 A1
(43) Pub. Date: Dec. 28, 2006

(54) Enhanced methods for media processing and distribution

(75) Inventor: Christopher William Gottschalk, Seguin, TX (US)

Correspondence Address: FULBRIGHT & JAWORSKI L.L.P., 600 CONGRESS AVE., SUITE 2400, AUSTIN, TX, 78701, US

(73) Assignee: KULA MEDIA GROUP

(21) Appl. No.: 11/438,673

(22) Filed: May 22, 2006

Related U.S. Application Data
(60) Provisional application No. 60/794,368, filed on Apr. 24, 2006.
(60) Provisional application No. 60/715,107, filed on Sep. 8, 2005.
(60) Provisional application No. 60/689,588, filed on Jun. 10, 2005.
(60) Provisional application No. 60/683,032, filed on May 21, 2005.

(51) Int. Cl. G06F 7/00

(52) U.S. Cl. 707/101

(57) ABSTRACT

Techniques for encoding and distributing media over a network such as the Internet. A media source is received as input. A plurality of time segmented media files are generated from the media source. The time segmented media files are compressed or decoded and distributed live, nearly live, or at a later time over the network.

This patent application claims priority to, and incorporates by reference in their entirety, U.S. Provisional Patent Application Ser. Nos. 60/683,032 filed on May 21, 2005, 60/689,588 filed on Jun. 10, 2005, 60/715,107 filed on Sep. 8, 2005, and 60/794,368 filed Apr. 24, 2006.

### BACKGROUND OF THE INVENTION

1. Field of the Invention

The invention relates generally to data communications. More particularly, it involves distributing media to client devices over a network including wireless media such as Internet Protocol.

2. Description of Related Art

With the advent of high speed communications networks such as broadband Internet, users may now readily access video and audio files, including streaming media. For example, Internet users can access video clips and music files for on-demand viewing or archiving for later use. Devices capable of receiving video and audio information are varied and now include not only computers, but also handheld devices such as laptops, Personal Digital Assistants (PDAs), cell phones, USB devices, and the like.

Despite advances in technology for distributing media, room for significant improvement remains. For example, it would be advantageous if techniques for collecting and distributing media were improved. It would also be advantageous if techniques associated with the compression of media were improved. Accordingly, a significant need exists for techniques described and claimed in this disclosure, which involve various improvements to the current state of the art.

### SUMMARY OF THE INVENTION

This disclosure involves, among other things, techniques for distributing media over a network such as the Internet. A media source is received as input. The input media source may be replicated. A plurality of time segmented media files are generated from the replicated input media. The time segmented media files are compressed and distributed over the network.

Alternatively, a media source may be received as input and may be stored in a buffer. Segmented portions of the media source may be extracted from the buffer and compressed. The compressed segmented portions are subsequently reassembled and distributed over a network. Alternatively, the reassembled portions may be stored for on-demand playback.

The term “media” refers to audio, video, or a combination of audio and video.

The term “client device” refers to any device capable of playback for the techniques described here and includes, but is not limited to, televisions, set top boxes, desktop computers, computer tablets, laptop computers, PDAs, gaming devices, handheld game devices, cell phones, and the like.

The term “real-time” refers to a continuous streaming of data to or from the client device of a live broadcast at substantially the actual time of broadcast.

The term “pipeline” refers to a real or virtual pathway for traversing of data (e.g., inputting, manipulating, outputting, etc.) using components such as, but not limited to, sources, filters, sinks, and the like. The traversing of data may be done in parallel (e.g., portions of the data may be manipulated while other portions may be outputted). Alternatively, the traversing of data may be done serially.

The term “source” refers to where the media data is obtained. In one respect, the source may be an external source such as, but not limited to, a broadcasting station (audio and/or video), a satellite feed, a cable box, DirecTV® box, and the like. The source may provide the media data to the pipeline.

The term “filter” refers to manipulating media streams in a pipeline. In some embodiments, manipulating may include, without limitation, encoding or encrypting the data, deleting portions of the data (e.g., removing bits), and/or adding data (e.g., adding bits).

The term “sink” refers to a port for receiving data and providing the data to, for example, a memory location, hard drive, network port, a client device, etc.

The term “GOB” refers to a group of bits relating to a media stream. For example, for a video stream, a GOB may refer to a group of pictures (GOPs). For an audio stream, a GOB may refer to a group of audio samples.

The term “keyframe” refers to a portion of a data stream to which a specific set of parameters are defined. In one respect, the keyframe may be a based on size (Kbits). In addition to or alternatively, the keyframe may be based on a unit of time. In one nonlimiting example, a keyframe may comprise information for the manipulation of other frames within a GOB.

The term “channel” refers to a live or prerecorded media source available for streaming or manipulating.

A compression process, as used in this disclosure, may be a technique to encode a segmented file in a format compatible with an end user device. Compression and encoding may be used interchangeably throughout this disclosure.

The term “identical” encompasses things that are identical or insubstantially different.

The term “coupled” is defined as connected, although not necessarily directly, and not necessarily mechanically.

The terms “a” and “an” are defined as one or more unless this disclosure explicitly requires otherwise.

The term “substantially” and its variations are defined as being largely but not necessarily wholly what is specified as understood by one of ordinary skill in the art, and in one-non and in one non-limiting embodiment the substantially refers to ranges within 10%, preferably within 5%, more preferably within 1%, and most preferably within 0.5% of what is specified.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more elements. Likewise, a step of a method or an element of a device that “comprises,” “has,” “includes” or “contains” one or more features possesses those one or more features, but is not limited to possessing only those one or more features. Furthermore, a device or structure that is configured in a certain way is configured in at least that way, but may also be configured in ways that are not listed.

### BRIEF DESCRIPTION OF DRAWINGS

The following drawings form part of the present specification and are included to further demonstrate certain aspects of the present invention. The figures are examples only. They do not limit the scope of the invention.

FIG. 1 shows a single channel input configuration for distributing media, in accordance with embodiments of this disclosure.

FIG. 2 shows a multiple channel input configuration for distributing media, in accordance with embodiments of this disclosure.

FIG. 3 shows a single channel, dual importer configuration for distributing media, in accordance with embodiments of this disclosure.

FIG. 4 shows a multiple channel input, dual importer configuration for distributing media, in accordance with embodiments of this disclosure.

FIG. 5 shows an example import node, in accordance with embodiments of this disclosure.

FIG. 6 shows a multiple input configuration, in accordance with embodiments of this disclosure.

FIG. 7 shows a technique for distributing media, in accordance with embodiments of this disclosure.

FIG. 8 shows a technique for compressing media files, in accordance with embodiments of this disclosure.

FIG. 9 shows compressing schemes, in accordance with embodiments of this disclosure.

FIG. 10 shows a technique for compressing media files at variable bit rates, in accordance with embodiments of this disclosure.

FIG. 11 shows a technique for decoding media files, in accordance with embodiments of this disclosure.

FIG. 12 shows a data stream, in accordance with embodiments of this disclosure.

FIG. 13 shows an encoding pipeline, in accordance with embodiments of this disclosure.

FIG. 14 shows a distribution pipeline, in accordance with embodiments of this disclosure.

### DETAILED DESCRIPTION

The disclosure and the various features and advantageous details are explained more fully with reference to the nonlimiting embodiments that are illustrated in the accompanying drawings and detailed in the following description. Descriptions of well known starting materials, processing techniques, components, and equipment are omitted so as not to unnecessarily obscure the invention in detail. It should be understood, however, that the detailed description and the specific examples, while indicating embodiments of the invention, are given by way of illustration only and not by way of limitation. Various substitutions, modifications, additions, and/or rearrangements within the spirit and/or scope of the underlying inventive concept will become apparent to those skilled in the art from this disclosure.

The present disclosure provides for streaming media to a variety of devices over a network. In a representative embodiment, streaming of media is done over an Internet Protocol, although this disclosure is not limited to that implementation. In one respect, analog or digital media sources are imported, converted into time segmented media files, and stored. The time segmented media is compressed and can be published immediately through media streams and/or archived for distribution. Client devices can subscribe to the published media streams or playback archived media files.

Pipelines

The process between receiving a data source and publishing the data source to a stream accessible by a client device for subsequent viewing or storing may include multiple pipelines. The data source may traverse through multiple different processes such as, filtration, encoding, distribution, reassembly, etc. The details of each of these processes are discussed in more detail below.

1. Encoding Pipeline

Referring to FIG. 13, an encoding pipeline is shown. The data source (e.g., video, audio, and/or a combination thereof) may be received (e.g., imported) from a source. The data may be provided to a first filter. In one embodiment, the first filter may determine where individual keyframes are located. The first filter may determine a keyframe based on a group of bits (GOB). Additionally or alternatively, the keyframe may be determined based on a unit of time (e.g., less than or equal to a time segmented file). In other embodiments, the keyframe may be based on the scenes (high intensity vs. low intensity).

Upon deciding the keyframes, the data may be provided to a bit detection rate filter. In one embodiment, the bit detection rate filter may scan the GOB and determine an average rate for manipulating (e.g., encoding) the GOB. For example if there are x number of GOBs, an average bit rate may be determined for each GOBs.

Next, an average rate for all the GOBs may be considered, and in particular, a variable bit rate for manipulation for each of the GOBs. In one respect, Eq. 1 (discussed below) may be used. The variable bit rate may be provided to a second filter for manipulating the data. In one respect, the second filter may be an encoding filter used for encoding each keyframe, or in general, each time segmented file using the determined variable bit rate. It is noted that the second filter may be a decoding filter or a reassembling filter which may reassemble the time segmented media files into one stream and provide the stream to a distribution pipeline. In addition to or alternatively, the second filter may be any other filter for manipulating the data source.

The manipulated data may subsequently be written to a buffer manager. In one respect, the number of buffers used may be proportional to the number of time segmented media files, where each buffer may store at least one time segmented media file.

2. Distribution Pipeline

The manipulated data source may be distributed from the buffer manager of the encoding pipeline via a sink, as shown in FIG. 14. In one respect, the sink may be coupled to a distribution server, which may handle the connection from the sink to the client devices. In one respect, the distribution server may be coupled to one or more client device(s) via a port sink.

In some embodiments, the distribution pipeline may include filters for reassembling time segmented media files. Alternatively or in addition to the above, the distribution pipeline may include other filters to, amongst other functions, manipulate the data source (e.g., the time segmented media files).

3. Client Pipeline

Upon receiving data from the port sink in the distribution pipeline, the data may be provided to the client device. In one respect, the data may be written and stored to a memory location on the client device using, for example, a sink. Alternatively, the data may be played on the client device, or otherwise manipulated on the client device.

Each of the above pipelines is discussed in more detail below with respect to the handling of the data source and the manipulation and subsequent distribution of data to at least one client device.

Importing and Storing Media

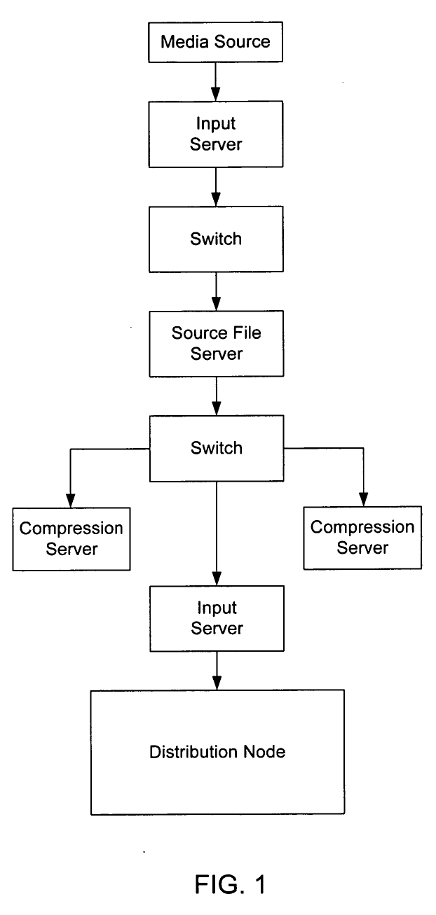

FIG. 1 is a block diagram showing an example importing technique. A media source (analog or digital, live or pre-recorded) is provided, via, for example, the encoding pipeline. In one embodiment, the media source may be clear text, plain text, or cipher text (e.g., character messages, bit messages, etc.). Alternatively, the media source may be an audio source in formats such as, but not limited to, Audio Interchange File Format (for MAC systems), AU (for Sun/Next Systems), CD audio, MP3, Windows Media Audio, QuickTime, RealAudio, WAV, and the like. The media source may also be a video source in formats including, but not limited to, MPEG, YUV, Digital Video, Windows Media Video, and the like. In other embodiments, the media source is a combination of video and audio, in formats such as, but not limited to, Audio Video Interleave (AVI). Any of the above listed media sources may be received from a satellite feed, a cable box, DirecTV® box, directly from broadcasting stations via links (e.g., optical fibers), or from any video or audio signal known in the art.

In one embodiment, the media source may be replicated (e.g., the signal may be multiplied into two or more identical media sources). The identical media sources may then be imported into a hardware capture device configured to receive and queue at least two identical media sources. Once the media sources are queued, they may be recorded.

In some embodiment, an import server, which may include a daemon, may be used to record two or more identical media sources in a time-alternating manner. In one embodiment, the first of two identical media sources are recorded for a predetermined time period, X. As the predetermined time period expires, the daemon stops recording the first of the two media sources and prompts for the second of the two identical media sources to be recorded for a time period Y, resulting in a time segmented media file. Time periods X and Y are equal in a preferred embodiment but may be different in other embodiments.

The daemon may also ensure that the recording of the second of the two identical media sources occurs from the precise point at which the first media source stopped recording. This, in turn, provides for seamless video and/or audio when the media is later streamed onto a client device or played from an archive.

This alternating recording scheme may be continued until an entire media source is recorded. In one embodiment, the daemon may store the time segmented media files on a source file server coupled to the import and compression servers. The daemon may also note the location of each time segmented media file and the corresponding order such that the complete media source may be pieced together at a later time. The media source may then be effectively streamed or archived for later viewing, using, e.g., a distribution mode and the distribution pipeline as discussed further below.

In other embodiments, a media source may be imported to a buffer configured to receive and queue a media source. Once the media source is queued, the media source may become available for encoding. For example, a daemon may be used to parse a segmented portion of the media source from a buffer and provide the segmented portion to an encoding daemon and/or compression server. In one embodiment, the daemon may parse segmented portions of the media source of substantially equal length, e.g., every segment may be a one second segment. Alternatively, the daemon may parse segments of the media source of varying lengths.

In other embodiments, the media sources may be parsed based on the data receive. In one embodiment, for a video media stream, using a scene detection sensor known in the art, pixel changes, and in particular, higher intensity of motion in a scene (e.g., a car chase versus a news broadcast). When the scene detection sensor detects a change in scene or a higher intensity of motion, the media source is parsed into a time segmented media file and provided to a compression server for encoding.

The time segmented media file may subsequently be provided to a buffer until the buffer is full (i.e., depending on the number of cores on the size of the time segmented media files), which allows for the flow of data to be controlled. In one respect, the flow of the time segmented media file to the encoder may be substantially equal to the input of the time segmented media file to the buffer.

Encoding Time Segmented Media Files

The alternating recording process or the segmented removal of a media source from a buffer, examples of which are described above, increases the throughput of a compression process and offers associated advantages. In one embodiment, a piece-wise compression process can take place for each time segmented media file, increasing the quality of compressed files. For example, one compression server, coupled to or integral with a source file server, may be provided. A daemon may be engaged to determine which time segmented media file (e.g., in what order and when to send the time segmented media file) is sent to the compression server. The compression server receives a first time segmented media file and compresses the time segmented media file for a set period of time. The compression process continues until all time segmented media files are completed.

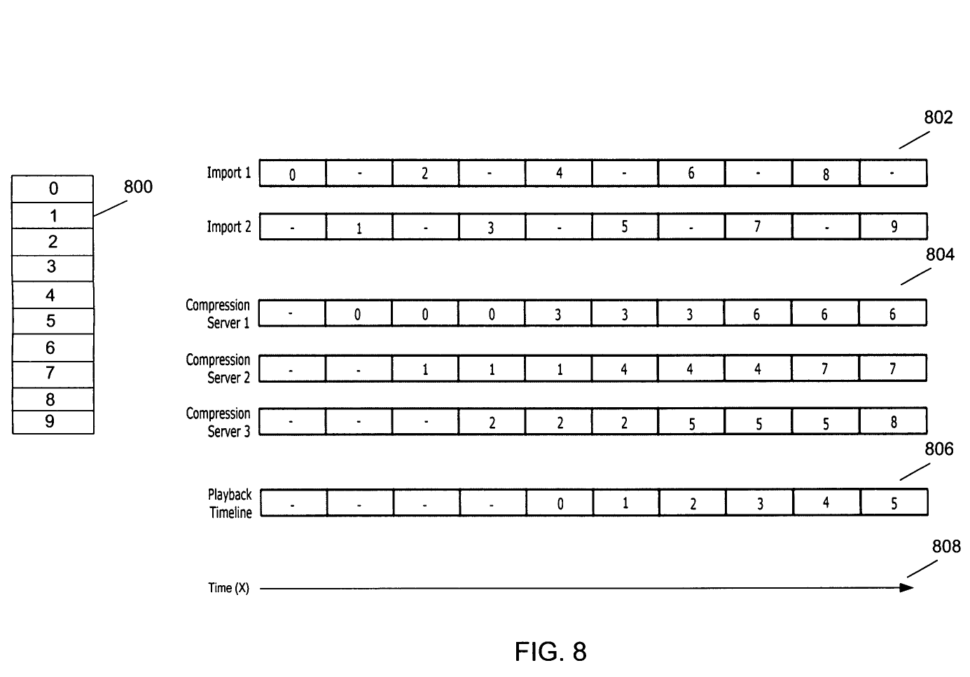

In other embodiments, in order to increase the compression quality of the time-segmented files and reduce latency, more than one compression server may be used. Referring to FIG. 8, an illustrative embodiment for compression using a three compression server configuration is shown. Block 800 includes ten time-segmented media files labeled 0 through 9. The ten time-segmented media files may make up a complete, single media file. Alternatively, block 800 may make up several media files. Block 802 illustrates an importing process using two importing schemes used in conjunction, Import 1 and Import 2. Block 804 illustrates three compression servers used to compress individual time segmented media files and block 806 illustrates a distribution process for the compressed time segmented media files. As shown in FIG. 8, blocks 802, 804, and 806 may operate on numerous segments, each segment representing a discrete time interval. Arrow 808 shows that the x-axis of FIG. 8 is a time-axis.

A daemon may be engaged to import the time segmented media files of block 800 to an appropriate compression server. For example, the daemon may import, using Import 1, time segmented media file 0 and provide time segmented media file 0 to Compression Server 1 of block 804. As shown, the importing process may take one time interval and as such, time segmented media file 0 is available for compression at Compression Server 1 at the second time interval. While time segmented media file 0 is being queued for compression, the daemon may retrieve and queue time segmented media file 1 using Import 2. Upon retrieving and queuing time segmented media file 1, the daemon may provide time segmented media file 1 to Compression Server 2 of block 804.

The daemon may alternate importing the time segmented media files from block 800 between Import 1 and Import 2. For example, when the daemon has completed the retrieval and importing process of time segmented media file 1 to Compression Server 2 using Import 2, it is available to retrieve and queue another time segmented media file, such as time segmented media file 2. After the importing and queuing of time segmented media file 2, the daemon may provide that file to Compression Server 3 of block 804. The alternating importing process may be repeated until all desired time segmented files are imported and provided to the appropriate compression server, as illustrated in FIG. 8.

In some embodiments, a single, sequential import scheme may be used. Using one importer, a daemon may retrieve and queue one time segmented media file and provide the file to a compression server. Upon sending the file to the compression server, the daemon may retrieve and queue a next time segmented media file for compression. Alternatively, a multi-importing scheme may be implemented using two or more importers. For example, a daemon may engage Import 1 through Import N, where N is greater than 2, to import and queue more than one time segmented media files and provide the time segmented media files to appropriate compression servers.

Referring again to FIG. 8, block 804 shows three compression servers working in parallel to compress individual time segmented files. In order to achieve high quality, each server may compress a time segmented media file for several time intervals. In one embodiment, the daemon may determine the length of time needed to compress a segmented media file. In the non-limiting example of FIG. 8, the compression process occurs for three time intervals. For example, upon receiving time segmented media file 0, Compression Server 1 may begin the compression process for the determined compression time. As shown in FIG. 8, time segmented media file 0 is compressed for 3 time intervals (beginning at second interval and ending at the fourth interval). At the end of the fourth interval, time segmented compressed media file 0 may be ready for distribution in the fifth interval, as seen in block 806. In one embodiment, the compression process may be a variable bit rate compression using an available codec or a customized codec. Alternatively, the compression process may be a constant bit rate compression.

As shown in FIG. 8, time segmented media file 1 is available for compression on Compression Server 2 at the third time interval. Due to the extended compression time, the compression of time segmented media file 1 can occur simultaneously with the compression of time segmented media file 0. At one point, three time segmented media files may be compressed simultaneously on different compression servers, e.g., at the fourth time interval of block 804, Compression Servers 1, 2, and 3 are compressing time segmented media files 0, 1, and 2, respectively. If more than three compression servers are used, even more time segmented media files may be compressed simultaneously.

Once the compression process is completed for a single time segmented media file, the segment may be ready for distribution. A daemon may be engaged to reassemble the compressed time segmented media files into their proper order and may distribute the files immediately or archive the media for future use. In one embodiment, during the encoding process, the compression may include tags, bits, or other indicators known in the art to distinguish the place of the time segmented media file with respect to the entire file. This may allow for the reassembling of the compressed time segmented media file in the proper order. The distribution process is discussed further below.

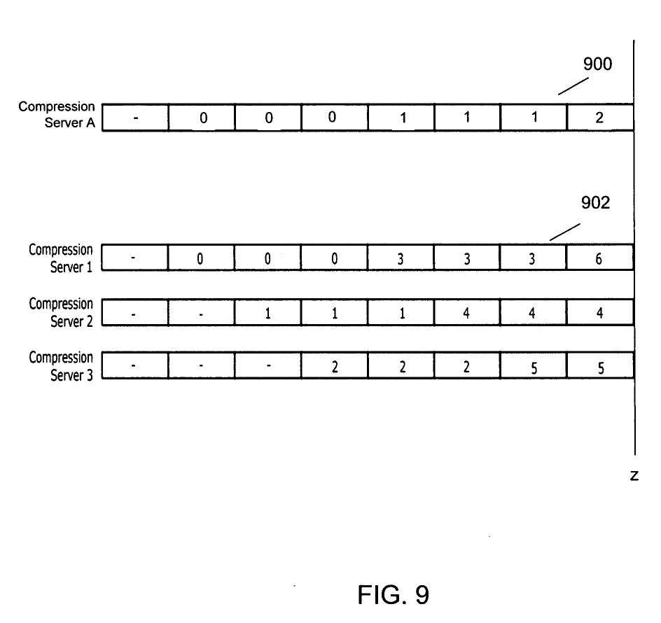

As illustrated in FIG. 9, by having more than one compression server operating in parallel, multiple time segmented media files may be compressed for multiple time intervals. This configuration allows a time segmented media file to be compressed for a longer amount of time and thereby, improves the quality. Further, by having multiple time segmented media files compressed in parallel, the delay between the completion of the compression process on one time segmented media file and the next is reduced. For example, referring to Compression Server 1 and Compression Server 2 of block 902, the compression of time segmented media file 0 (for three time intervals) is completed at the fourth time interval and the compression of time segmented media file 1 is completed at the fifth time interval. The delay in this configuration is 1 time interval. By comparison, if only one compression server is used (block 900) and a media file is compressed for three intervals, the delay between the completions of the compression process of the first time segmented media file and the second time segmented media file and would be 3 time intervals. This is due to the serialization of the compression process. In a one compression server configuration, a compression of one time segmented media file needs to be completed before the compression of another media file begins. Additionally, at time Z, block 902 has completed the compression of five time segmented media files as compared to the two time segmented media files of block 900. As such, by increasing the number of compression servers used, the quality of the compressed media file and the number of time segmented media files processed increases.

In order to maximize the number of time segmented media files being compressed, the delay between the completions of the compression of one time segmented media file and the next needs to be kept at a minimum. Ideally, the delay between the completion of the compression of one time segmented media file and the next is equivalent to the time it takes to compress one time segmented media file. For example, referring to Table 1, in a single compression server configuration (column 2), maintaining a minimum delay between compression completions requires each time segmented media files to be compressed for only one time interval. As the number of compression server increases, each time segmented media file may be compressed for more time intervals, while still maintaining this minimum delay. For example, in a five compression server configuration, each time segmented media file can be compressed for 5 intervals, yet still achieve the minimum delay between the completion of the compression process of one time segmented media file and the next. This is due to the parallel process shown in blocks 804 and 902 of FIGS. 8 and 9, respectively.

TABLE 1

| | | | | | |
|---|---|---|---|---|---|
| # of Compression servers | 1 | 2 | 3 | 4 | 5 |
| # of Time Intervals | 1 | 2 | 3 | 4 | 5 |
| Compression Takes Place | | | | | |
| Quality Setting | 1 | 2 | 3 | 4 | 5 |
| Playback delay from source | 2x | 3x | 4x | 5x | 6x |

Increasing the number of compression servers while reducing the delay between the completion of the compression process of one time segmented media file and the next also allows for each time segmented media file to be compressed for multiple intervals, thus improving the quality. As seen in Table 1, a quality setting can increase as the number of server increases. While the ultimate delay for distribution of the media file may be longer when more servers are used, the quality of the compression process may offset the time delay. For example, the quality of a time segmented media file in a five compression server configuration may be significantly better (with only a 4× ultimate distribution delay, where x is an interval of time) when compared to the one compression server configuration.

A daemon of any of the above embodiments may determine an appropriate compression ratio. In one embodiment, the daemon may run different compression schemes corresponding to different types of client devices, including, without limitation, computers, PDAs, cell phones, set top boxes, laptops, etc. For example, a more aggressive compression scheme may be used for one or more particular types of client devices. Multiple compression files may be compressed from one time segmented media file. The compression process for different compression ratios may be done simultaneously, or at different times. For example, a compression server may process time segmented media files for one compression ratio before starting another compression ratio. The compressed files may be provided to at least one media file server via a switch coupled to the compression server for storage. In one embodiment (such as the embodiment of FIG. 8), a plurality of compression servers may be provided, forming a cluster configured to write compressed time segmented media files.

It is noted that the above embodiments may be performed on hardware such as the compression servers shown, for example, in FIG. 8. Alternatively, multiple compression daemons may be configured to compress time segmented media files as described above. In one embodiment, a single multi-core processor may be used to perform the parallel compression techniques discussed here, which may eliminate or reduce a need for multiple pieces of hardware. In general, different segmented media files can be compressed in parallel in different threads or processes using a single or multiple processors, or a single or multiple compression servers. In one embodiment, a combination of hardware and daemons may be configured to implement the compression process.

1. Variable Bit Rate Encoding

In one embodiment, a variable bit rate may be used to encode a time segmented media file of a media source, such as, for example, a live broadcast. Currently, constant bit rates are typically used to encode a live broadcast and publish data over a network to a client device. However, the constant bit rate may produce a degraded quality, especially in frames which may have complicated or high-movement video or audio content.

The present disclosure provides for a variable bit rate encoding process to increase quality as well as provide substantially real-time media to an end user. Segments of a media source, either stored as segmented files in an import server or segments of a media source taken from a buffer, may be encoded at variable bit rates depending on, among other factors, the complexity of the segmented media source.

In one embodiment, a target client bit rate (Kbits/second) may be determined or provided. The target client bit rate may be associated with, for example, a digital subscriber lines (DSL), cable network, or other broadband networks. In one embodiment, the target client bandwidth may be chosen with a particular type of client device having a particular type of broadband connection in mind. For example, if media is to be streamed to a cell phone, one may assign or have designated (automatically or manually) a target client bandwidth that takes into account the type of device and type of telecommunications network that device is connected to.

A client capacity may be determined, where, in one embodiment, the client capacity is the product of the targeted client bit rate and the client buffer size (the client buffer size, in this example, being measured in units of time). This calculation can be used to generally determine a typical capacity of the client side and can be used to ensure that the variable bit encoding process does not exceed a pre-determined threshold.

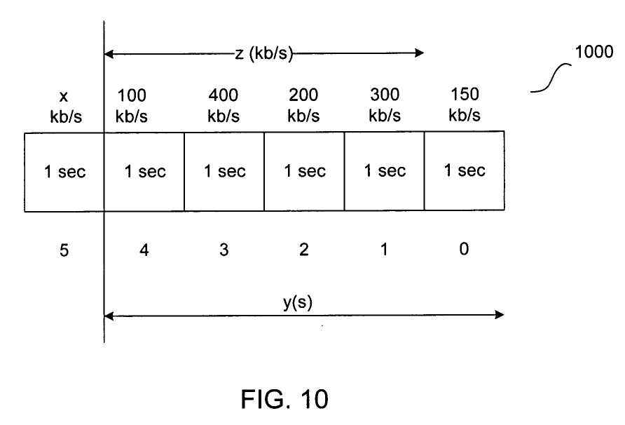

Referring to FIG. 10, client buffer 1000 may have a buffer size of 5 seconds. To determine a variable encoding bit rate for a particular media segment to be delivered to the client, the client capacity may be used as part of a calculation.

In FIG. 10, segmented media files 0, 1, 2, 3, and 4 have been previously encoded at varying bit rates of 150 Kbits/second, 300 Kbits/second, 200 Kbits/second, 400 Kbits/second, and 100 Kbits/second, respectively. In order to find an encoding bit rate for segmented media file 5, the following equation may be used:

$$\frac{( {\sum }_{i = 1}^{z} {( Previous Segment BitRate )}_{i} ) + x}{y} \leq targeted client bit rate \qquad Eq . 1$$

where x is the variable encoding bit rate for a current segmented media file that needs to be compressed (e.g., segmented media file 5 of FIG. 10), y is equal to the client buffer size (here, measured in units of seconds), z is the number of previous segments that can fit in the client buffer with the segment that needs to be compressed (here, 4, since 4 previous segments plus the segment being compressed will fit in the client buffer), and the targeted client bit rate is the value discussed above, which can be chosen, designated, or the like according to need or desire. In one embodiment, the targeted client bit rate is automatically selected based on information stored about the client or through a communication with the client itself.

Eq. 1 may also be written with respect to the client capacity, which, as noted above, is the product of the targeted client bit rate and the client buffer size (y), as follows:

$$( {\sum }_{i = 1}^{z} {( Previous Segment BitRate )}_{i} ) + x \leq client capacity \qquad Eq . 2$$

In the example of FIG. 10, if the targeted client bandwidth is 700 Kbits/second, Eq. 1 would yield:
[(100+400+200+300)+x]/5 is less than or equal to 700.
Solving for x (which is less than or equal to the client capacity less

$$( {\sum }_{i = 1}^{z} {( Previous Segment BitRate )}_{i} ) ) ,$$

one finds that the 5^{th} segmented media file can be encoded at a bit rate up to about 2500 Kbits/second without exceeding client capacity.

The variable encoded bit rate for segmented media file 5 in this example is greater than the targeted bandwidth of the client. This is possible due to the allocation of extra bandwidth not used during the encoding of prior segmented media files.

Using Eqs. 1, 2, or other similar equations or calculation schemes, which may be determined dynamically, each segmented media file may be encoded at an appropriate variable bit rate. This process may allow for high quality and efficient streaming, even for video that contains highly complex scenes.

For a staggered or multi-compression server scheme (i.e., FIG. 9), the bit rates of previous segmented media files may not be known. In one embodiment, a daemon may be engaged to scan the time segmented media file and determine or estimate the bit rate of previous segmented media files. Using, for example, Eqs. 1 or 2 and the estimated and/or actual bit rates of previous segmented media files, a maximum bit rate for subsequent media files may be determined.

After encoding the segmented media files, the files may be reassembled and distributed to the client. For devices that subscribe to a live broadcast, the encoding technique described above allows the device to begin receiving the encoded live broadcast in substantially real time. For example, upon completion of the encoding process, a daemon may be engaged, where the daemon may provide the encoded time segmented media file to the end user device such that continuous playback is achieved. The distribution process is discussed in more detail below.

2. Sliding Window

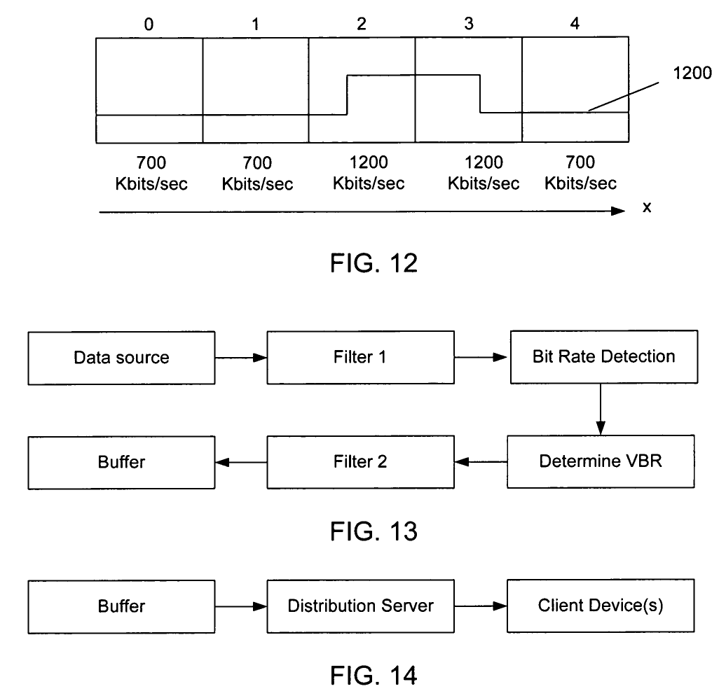

Referring to FIG. 12, time segmented media files 0 through 4 are shown where each segment includes x seconds of data (e.g., 5 seconds of data), and where x is less than or equal to the size of a client buffer. The time segmented media files 0 through 4 includes media stream 1200. In one embodiment, data stream 1200 may be a text stream, an audio stream, a video stream, or a combination of the above. Additionally, media stream 1200 may include multiple media files or alternatively, one media file.

Media stream 1200 may include varying “intensities” of data. For example, between time segmented media files 0 and 1, the data is an even stream. A spike, or higher intensity in media stream 1200 (as seen in time segmented media files 2 and 3) may represent, for example in video data, an increase in pixilation (e.g., a high speed car chase).

In current implementations, time segmented media files 0 and 1, which may be encoding at about the target client bandwidth rate (e.g., 700 Kbits/sec), may not cause the client buffer to overflow. However, for time segmented media files 2 and 3, each having an encoding rate at about 1200 Kbits/sec, the client buffer may be exceeded because current client buffer design queues based on time. In other words, the client buffer would only be capable of receiving only a portion of the data that have been encoding at the higher encoding rate. Therefore, data may be lost.

The present disclosure provides a sliding window, where the client buffer will buffer the data stream based on the amount of data that the buffer may handle, prior to playing or storing the encoded data stream. In one embodiment, to determine the amount of data the buffer may handle, the size of the buffer (in units of time) and the maximum target client bit rate is determined (in numbers bits per unit of time). For example, the size of the buffer, x, may be 5 seconds and the maximum target client bandwidth rate is 700 Kbits/sec, yielding:
5 secs·700 Kbits/sec=3500 Kbits.
Once the client buffer receives 3500 Kbits worth of data, the client buffer may process the data accordingly. The data stream sent to the client buffer is not interrupted and the data being transmitted is not lost as compared to current techniques for uploading to a client buffer.

3. Maximum GOBs

In one embodiment, the encoding rate may depend on the time segmented media files. In particular, the encoding rate may depend on the keyframes, where one keyframe may be less than or equal to a time segmented media file. In one respect, a frame by frame analysis may be performed to determine the bit rate. The GOBs from the keyframes may be analyzed to determine a maximum GOB (in terms of time). In one embodiment, the maximum GOB is leas than or equal to the client buffer.

4. Digital Data Transmission

Generally, multiple-program transmissions are encoded, multiplexed, and transmitted over a single communication channel. Since these programs share the bandwidth of the channel, the bit rate for coding these programs must be less than the communication channel rate. Conventionally, this has been achieved by controlling the individual program bit rate using a statistical multiplexer (stat mux). The stat mux allocates channel capacity amongst the program to accommodate for the needs of a program. For example, when two channels have the same allocated bandwidth, and one channel broadcasts a sports program having frequent motions and another channel broadcasts a news program, the quality of the picture of the sports program may be inferior to quality of the news program. Thus, to accommodate for frequent motions or data intense programs, a stat mux may reallocate bandwidth from one channel, e.g., channel broadcasting a news program, to a channel with that requires more bandwidth, e.g., channel broadcasting a sports program.

In one embodiment, the encoding techniques of the present disclosure may be used for digital video compression (DVC) to improve the quality of the digital data transmission for multi-program environments, including cable or satellite applications. Programs on a channel may be broken up into a plurality of time segmented files and may be provided to at least one compressor server. In one embodiment, the compression process may be sequentially, where a first of the time segmented media files is provided to a compressor, followed by the second, third, and so forth, similar to Compression Server A of FIG. 9. Alternatively, a plurality of compression servers may be provided such that a concurrent, parallel compression process may be performed. For example, referring to block 902 of FIG. 9, a first time segmented file of a program may be retrieved and provided to a first compression server. During the compression of the first time segmented file, a second time segmented file may be retrieved and provided to a second server.

In other embodiments, a variable bit rate compression process may be used to compress the time segmented files of the program. The bandwidth of the transmission (e.g., from the broadcaster to the receiver) and the receiver capacity may be determined. The receiver capacity is the product of the transmission bandwidth and the buffer size (the buffer size in this example being measured in units of time). This calculation can be used to generally determine a typical capacity of the receiver and can be used to ensure that the variable bit encoding process does not exceed a pre-determined threshold. Using, for example, Eq. 1, time segmented files of the program may be encoded at variable bit rates by evaluating the bit rates of previously encoded time segmented files and the receiver buffer size.

Distribution

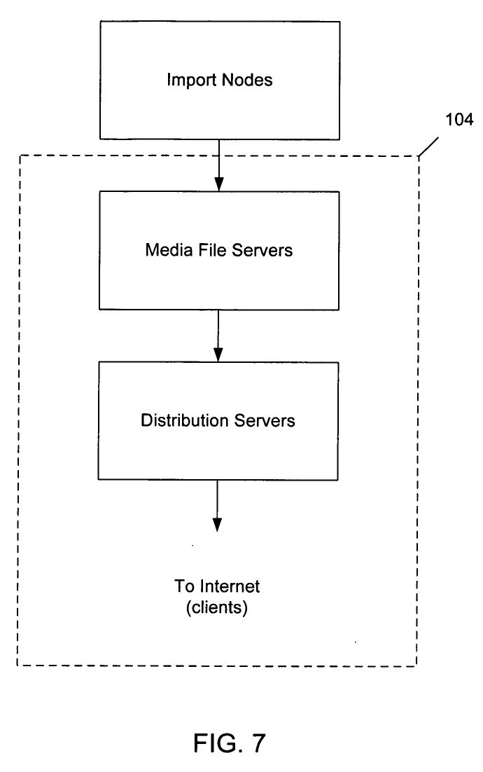

In one embodiment, compressed time segmented media files may be published immediately upon compression (e.g., live or substantially live) using a distribution node (see, e.g., distribution node 104 of FIG. 7). In another embodiment, compressed time segmented media files may be archived for later distribution using a distribution node. Such distribution may give clients the ability to, e.g., view a television program or other media “on-demand” even well after the original program aired.

In one embodiment, the compressed time segmented media files may be recompiled into a stream via a daemon coupled to or implemented on at least one distribution server and configured to provide instructions to add new media files to the stream. The daemon may also determine what files are appropriate for a particular client device and determine what compressed time segmented media files to export from media file server(s) via the distribution server. Additional streams may be created from one or more existing streams. Alternatively, additional streams may be created for other compressed time segmented media files.

An end-user may have the option of subscribing to a published stream or playing archived media files. For example, a graphical user interface (GUI) may be provided on a client device that is configured to select a stream. Alternatively, the end-user may use controls on a client device to select a stored media file (e.g., selecting media to view “on demand”). In one embodiment, an end-user may be able to search for published streams or archived files accessible by the client devices. In one embodiment, an end-user may indicate the type or level of compression he or she would like for a selected media. Information relating to the type of client device, such as, but not limited to, network conditions, connection type (broadband access, dial-up modem, etc.), and the type of client device may be automatically (or manually) used to determine the most appropriate media suited for the end-user's environment, e.g., appropriate media files that are compressed to desirable ratio for the device.

Information gleaned from a client device or from client requests may be used for interactive media applications, targeted marketing, and the like. For example, one may determine viewing habits of one or more users by storing and analyzing media requests along with other information such as the type of client device making a request. With a subscription service in place, even additional information may be gleaned. For example, one may determine the age and sex of users who request a particular program for playback on a particular type of device. As those having ordinary skill in the art will comprehend, this type of information may serve as a very powerful tool for various applications, marketing being at least one.

Decoding Techniques

In some embodiments, a media file, may need to be decoded. For example, for digital broadcasting, a media source (e.g., an audio and/or video source) is generally transmitted via a wireless medium, such as the Internet. In order to increase and improve the transmission of the data in digital format, the media source may first be compressed using, for example, the compression techniques described above according to standards, such as, but not limited to, the Moving Picture Experts Group (MPEG) standard. The compressed files may subsequently be decoded at the receiver end.

Similar to the compression techniques described above, a decoding process may include a piece-wise decoding of the media file. In one embodiment, using the compression process described above, the compressed time segmented media files may be transmitted over an Internet Protocol and may be received by a client device. Alternatively a compressed media file may be transmitted over an Internet Protocol and may be recorded into time segmented media files, using similar techniques as described above. In other embodiments, segmented portions of the compressed media source may be extracted and provided to at least one decoder.

In one embodiment, individual compressed time segmented media file may be provided to a decoder in a sequential manner. Upon completion of the decoding process, the decoded time segmented media files may be recompiled into a stream using, for example, a daemon, which may be configured to provide instructions to add decoded time segmented media files to the stream.

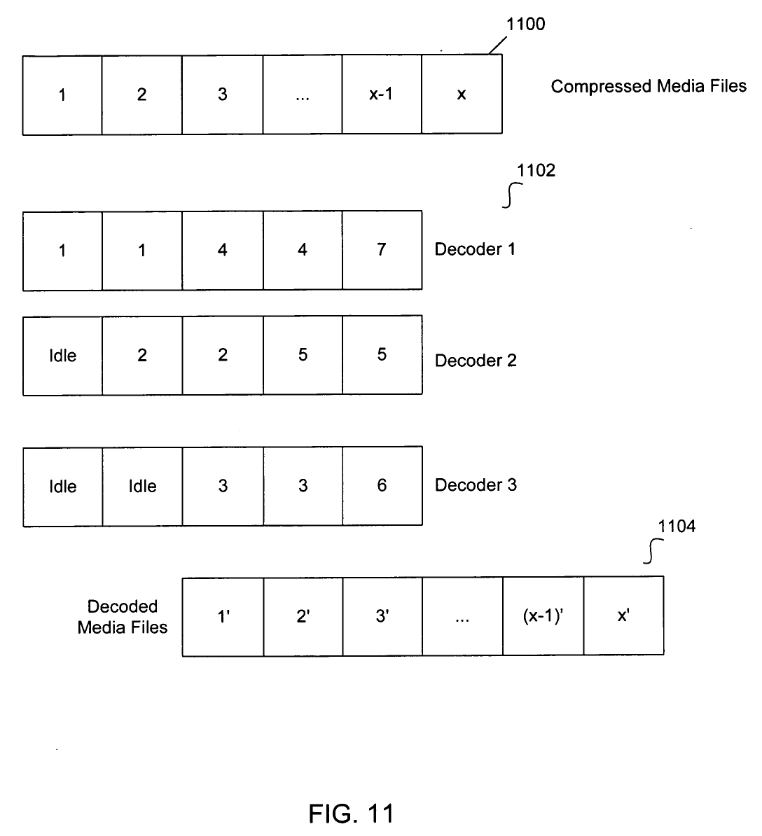

Alternatively, in order to increase the reduce latency in the decoding process, more than one decoders may be used. Referring to FIG. 11, an illustrative embodiment for decoding using three decoders is shown. Block 1100 includes x number of compressed time-segmented media files labeled 1 through x. The plurality of compressed time-segmented media files may make up a complete, single media file. Alternatively, block 1100 may make up several media files. Block 1102 illustrates three decoders used to decode the compressed time segmented media files. Each of the decoders may operate on numerous segments, each segment representing a discrete time interval.

In one embodiment, a daemon may be engaged to import the compressed time segmented media files of block 1100 to an appropriate decoder server. The retrieving of the compression time segmented media files may be done sequential, and as such, the decoding process of multiple compression time segmented media files may be in a staggered fashion. For example, compressed time segmented media file 1 may be provided to Decoder 1 of block 1102. As shown in FIG. 11, compressed time segmented media file may be decoded for 2 discrete time interval. While time segmented media file 1 is being decoded, the daemon may retrieve and provide compressed time segmented media file 2 to Decoder 2 of block 1102. As such, during the time of retrieving compressed time segmented media file 2, Decoder 2 may be idle, as illustrated in FIG. 11. Similarly, during the decoding of compressed time segmented media file 2, a daemon may retrieve compressed time segmented media file 3 and provide it to Decoder 3.

Upon completion of decoding process, Decoder 1 may provide decoded time segmented media file 1′, which may be recompiled with other decoded time segmented media files e.g., decoded time segmented media file 2′, 3′, etc., to form a completed media file.

Additionally, Decoder 1 may be available to receive another file to decode, such as compressed time segmented media file 4, as shown in FIG. 11.

Alternatively, in other embodiments, the retrieving of the compressed time segmented media files may be done in parallel, where multiple daemons may be employed to retrieve and provide compressed time segmented media files to available decoders. For example, if Decoders 1, 2, and 3 are available, a plurality of daemons retrieve three compressed time segmented media files simultaneously and provide to Decoders 1, 2, and 3 one of the retrieved files. Upon completion of the decoding process, a daemon may be engaged to recompile the decoded time segmented media files in a proper order for playback on the client device.

Scalability

The above techniques for distributing media over an Internet Protocol may be modified and scaled, as will be apparent to those of ordinary skill in the art having the benefit of this disclosure. In one embodiment, the media source imported may be multiplied into a plurality of identical media sources. In this embodiment, more than one hardware capture device may be used to receive a plurality of identical media sources. Alternatively, one hardware capture device may be configured to receive a plurality of identical media sources.

1. Multi-Channel Input Configuration

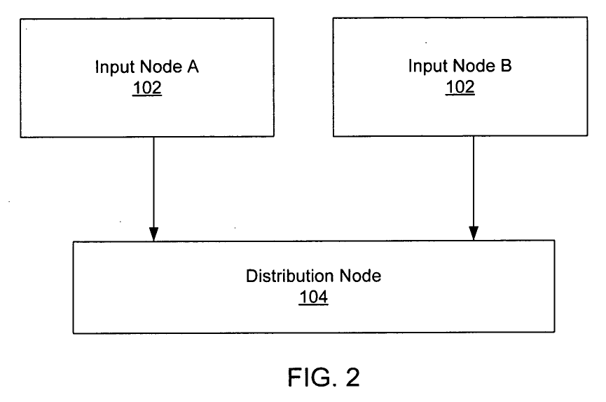

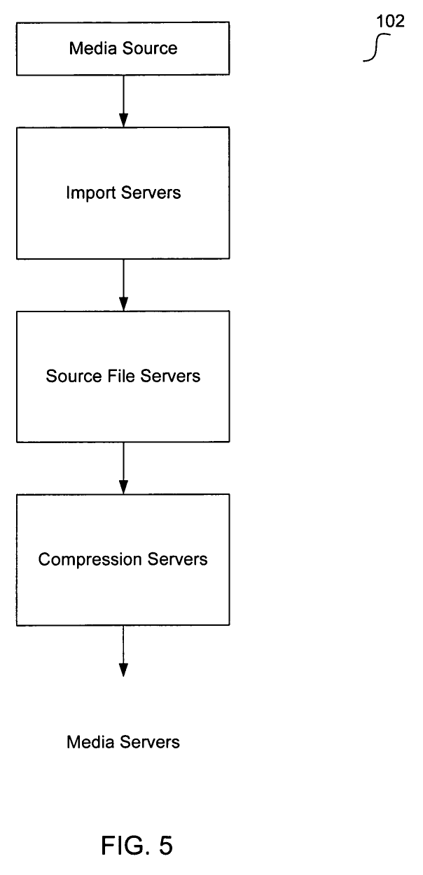

More than one media source may be received simultaneously, in a multi-channel input configuration. Referring to FIG. 2, two import nodes are shown—import node A and import node B, both labeled as element 102. Each of these import nodes may be similar to the import node of FIG. 1 (the upper portion of FIG. 1 above the distribution node) or FIG. 5 (the boxed elements). In other words, the import node of, e.g., FIG. 1 may be replicated to accommodate more than one media source. Similar to the single channel input configuration of FIG. 1, import node A 102 and import node B 102 may each receive a media source, replicate the media source into at least two identical signals, record time segmented media files in an alternating recording process, and store individual time segmented media files onto a source file server. Source file servers may be provided to store time segmented media files from an appropriate import node 102 and send the time segmented media files for compression and then to distribution node 104 for distribution.

2. Single Channel Input, Dual Importer Configuration

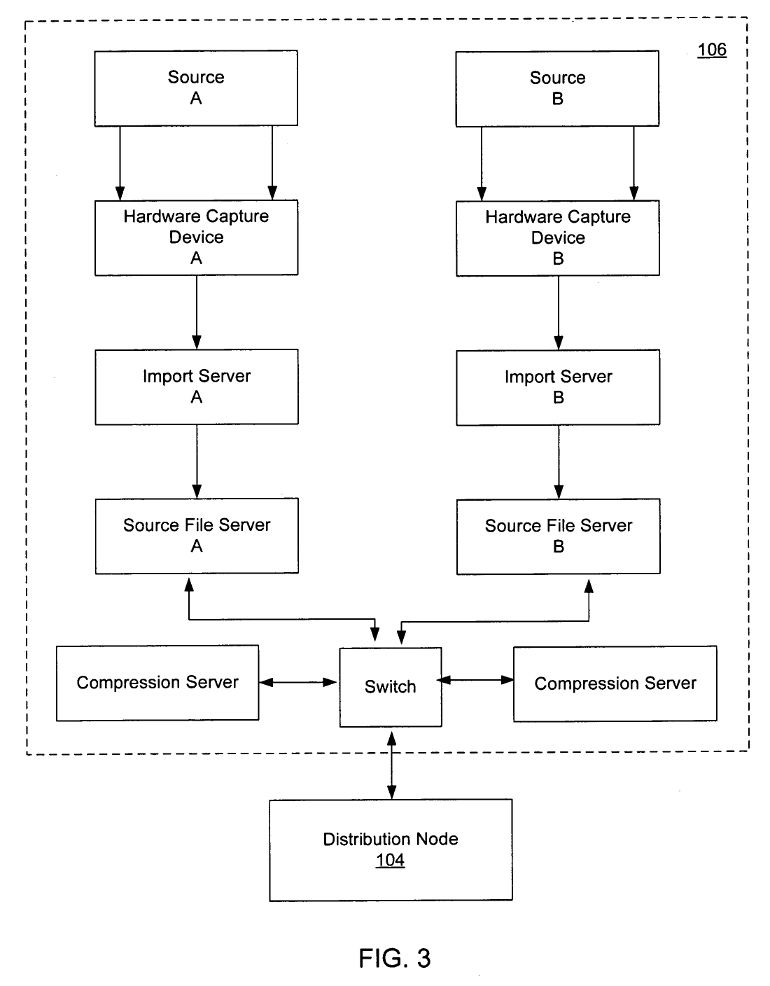

In other embodiments, a single channel input configuration may be used, similar to that shown in FIG. 1, but with a dual importer, as seen in FIG. 3. Dual importer refers generally to an import process in which a plurality of servers may be used for capture. Source A may be received, replicated, recorded into time segmented media files using an alternating recording process, and stored in source file server A. Source B may also be may be received, replicated, recorded into time segmented media files using an alternating recording process, and stored in source file server B. The receiving and recording process for Source A and Source B may occur simultaneously. Alternatively, the receiving and recording process may occur sequentially. In a representative embodiment, Source A is identical to Source B. In different embodiments, however, Source A may be a separate, distinct media file, which is not necessarily similar to Source B.

Upon recording the time segmented media files of Source A and/or Source B, a compression process may be implemented. A compression server, which may include a daemon for providing instructions for the compression process, selects appropriate time segmented files from either source file server A and/or source file server B, performs the compression process, and sends compressed time segmented files to at least one server in distribution node 104 for storing and eventual distribution. Upon distribution, the compressed time segmented files may be recalled, reassembled, and distributed over an Internet Protocol.

3. Multi-Channel Input, Dual Importers Configuration

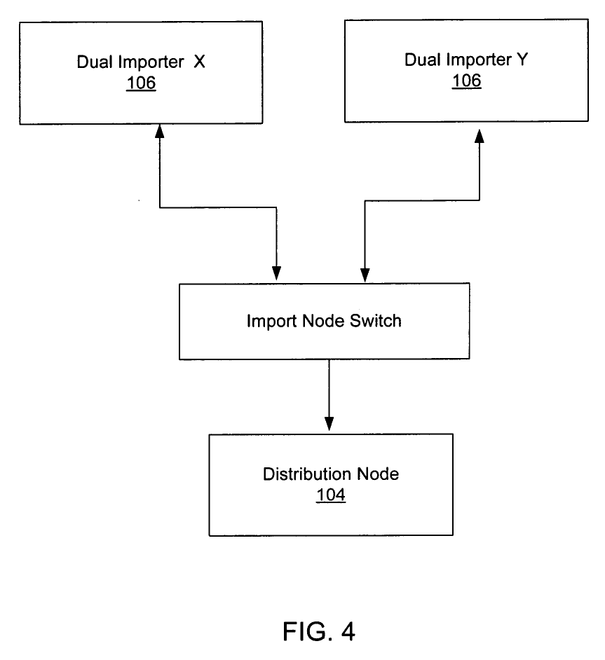

As noted above, more than one media source may be received simultaneously, in a multi-channel input configuration. Dual importer 106 of FIG. 3 may be replicated and may be used to import multiple media sources simultaneously or at a different time. In one embodiment, dual importer X 106 and dual importer Y 106 in FIG. 4 may each receive Source A and Source B, replicate the source into two identical signals, record time segmented media files in an alternating recording process, and store the time segmented media files in a source file server. A daemon may be provided to select time segmented media files from the source file server in dual importer 106 X or Y and send the time segmented media files to compression servers and then on to the distribution node.

### Additional Example Embodiments

FIGS. 5-7 illustrate additional, example embodiments for implementing techniques of this disclosure. In FIG. 5, an example import node is shown. A media source, such as a video source, audio source, or a video and audio source is input and replicated. The replicated media is processed in a time alternating manner by one or more import servers and stored as time segmented media files on one or more source file servers. The time segmented media is compressed by one or more compression servers and stored as compressed time segmented media files on one or more media servers.

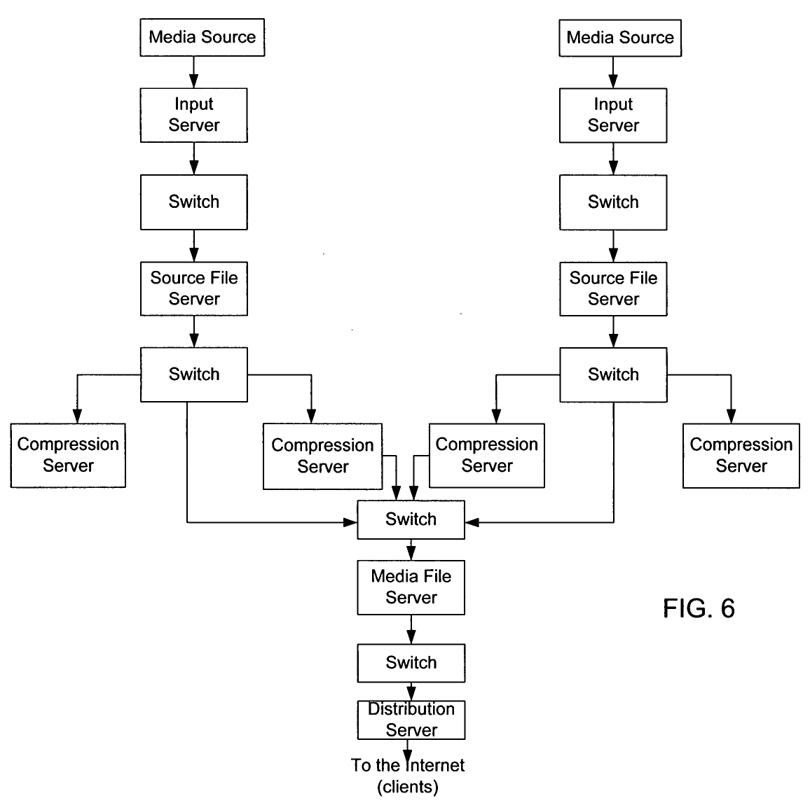

Alternatively, multiple media files may be input simultaneously, as seen in FIG. 6. Similar to FIG. 5, the media sources are replicated and processed into multiple time segmented media files and transferred for storage in one or more source file servers via a switch. The multiple time segmented media files is subsequently compressed using one or more compression servers and transferred to one or more time segmented media files. Upon distribution, either live or “on demand,” a daemon coupled to the distribution server retrieves appropriate compressed time segmented media files and reassembles the media files into proper order and publishes the file via an internet protocol.

In FIG. 7, an additional flowchart is provided to demonstrate an example distribution node for distributing media processed as described above. One or more import nodes, such as the embodiment shown in FIG. 5, process media in a time alternating manner to produce time segmented files, which are compressed and moved to media servers, which are delivered to, e.g., Internet clients via distribution servers.

Techniques of this disclosure may be accomplished using any of a number of programming languages. Suitable languages include, but are not limited to, BASIC, FORTRAN, PASCAL, C, C++, C#, JAVA, HTML, XML, PERL, etc. An application configured to carry out the invention may be a stand-alone application, network based, or Internet based to allow easy, remote access. The application may be run on a personal computer, PDA, cell phone or any computing mechanism. Content from the application may be pushed to one or more client devices.

Computer code for implementing all or parts of this disclosure may be housed on any computer capable of reading such code as known in the art. For example, it may be housed on a computer file, a software package, a hard drive, a FLASH device, a USB device, a floppy disk, a tape, a CD-ROM, a DVD, a hole-punched card, an instrument, an ASIC, firmware, a “plug-in” for other software, web-based applications, RAM, ROM, etc. The computer code may be executable on any processor, e.g., any computing device capable of executing instructions for traversing a media stream. In one embodiment, the processor is a personal computer (e.g., a desktop or laptop computer operated by a user). In another embodiment, processor may be a personal digital assistant (PDA), a gaming console, a gaming device, a cellular phone, or other handheld computing device.

In some embodiments, the processor may be a networked device and may constitute a terminal device running software from a remote server, wired or wirelessly. Input from a source or other system components may be gathered through one or more known techniques such as a keyboard and/or mouse. Output, if necessary, may be achieved through one or more known techniques such as an output file, printer, facsimile, e-mail, web-posting, or the like. Storage may be achieved internally and/or externally and may include, for example, a hard drive, CD drive, DVD drive, tape drive, floppy drive, network drive, flash, or the like. The processor may use any type of monitor or screen known in the art, for displaying information. For example, a cathode ray tube (CRT) or liquid crystal display (LCD) can be used. One or more display panels may also constitute a display. In other embodiments, a traditional display may not be required, and the processor may operate through appropriate voice and/or key commands.

With the benefit of the present disclosure, those having ordinary skill in the art will recognize that techniques claimed here and described above may be modified and applied to a number of additional, different applications, achieving the same or a similar result. For example, those having ordinary skill in the art will recognize that different types or numbers of servers or storage may be used to implement the techniques of this invention. For example, different servers may be consolidated or separated as desired. The use of switches and their location may also vary, and in certain embodiments switch alternatives or other techniques may be used. The attached claims cover all such modifications that fall within the scope and spirit of this disclosure.

1. A method for distributing media over a network, comprising:
receiving as input a media source;
generating a plurality of time segmented media files from the input media;
compressing the time segmented media files at variable bit rates;
reassembling the compressed time segmented media files; and
distributing media over the network using the time segmented compressed media files.

2. The method of claim 1, where receiving comprises receiving as input a text source, an audio source, a video source, or a combination thereof.

3. The method of claim 1, where generating comprises parsing the input media into time segmented media files.

4. The method of claim 1 further comprising importing one time segmented media files to a compression server.

5. The method of claim 1, where compressing comprises compressing into a plurality of different compression ratios based on a bandwidth capacity of a client device requesting the media.

6. The method of claim 1, where compressing comprises compressing a first time segmented media file on a compression server and a compressing a second time segmented media file on a second compression sever in parallel with the compression of the first time segmented media file.

7. A program storage device readable by a machine, tangibly embodying a program of instructions executable by the machine to perform the function of claim 1.

8. A method, comprising:
determining a targeted client bit rate;
determining a size of a client buffer;
determining a capacity of the targeted client based on the bandwidth and the size of the buffer;
receiving as input a media source; and
encoding a portion of the media source media at a pre-determined variable bit rate, the pre-determined variable bit rate being calculated so that the capacity of the targeted client bit rate is not exceeded.

9. The method of claim 7, where the pre-determined variable bit rate is calculated using (a) the product of the targeted client bandwidth and the size of the client buffer and (b) a sum of variable bit rates for previously encoded portions of the media source.

10. A program storage device readable by a machine, tangibly embodying a program of instructions executable by the machine to perform the function of claim 1.
